(19) United States
(12) Patent Application Publication
(10) Pub. No.: US 2014/0186882 A1
(43) Pub. Date: Jul. 3, 2014

(54) METHOD FOR FIXING A HISTOLOGICAL SAMPLE

(71) Applicant: Leica Biosystems Nussloch GmbH, Nussloch (DE)

(72) Inventors: Markus Berberich, Heidelberg (DE); Ralf Eckert, Schriesheim (DE)

(73) Assignee: Leica Biosystems Nussloch GmbH, Nussloch (DE)

(21) Appl. No.: 14/138,077

(22) Filed: Dec. 22, 2013

(30) Foreign Application Priority Data
Dec. 28, 2012 (DE) 10 2012 224 535.9

(51) Int. Cl. G01N 1/30; G01N 1/31

(52) U.S. Cl. CPC G01N 1/30; G01N 1/31
USPC 435/40.52; 422/536; 422/82.02

(57) ABSTRACT

The disclosure relates to a method for fixing a histological sample, in which a target fixing time for the sample is defined and the sample is exposed to the action of a fixative, the exposure start time being stored in a memory associated with the sample. The sample is no longer exposed to the fixative when an action time of the fixative on the sample is equal to or greater than the target fixing time.

### CROSS REFERENCE TO RELATED APPLICATIONS

This application claims priority of German patent application number 10 2012 224 535.9 filed Dec. 28, 2012, the entire disclosure of which is incorporated by reference herein.

### FIELD OF THE DISCLOSURE

The present disclosure relates to a method for fixing a histological sample, to a sample receptacle, in particular a cassette or cassette holding apparatus or fixing container, for receiving a histological sample, and to a processing apparatus for processing a histological sample.

### BACKGROUND OF THE DISCLOSURE

It is known from the existing art how to prepare a biological tissue sample for a histological investigation. It is known, for example, that a sample that has been taken is cut in a trimming station and inserted into a cassette. The sample is then prepared for a microscopic investigation using a plurality of chemical treatments. In the chemical treatment, firstly the sample is fixed with a fixative, in which context the water present in the water is removed, and optionally further processing steps are completed. The sample is then embedded into paraffin or wax. The paraffin block is sectioned into individual thin tissue sections for investigation with a microscope.

It often occurs in practice that further processing of the sample, or the performance of diagnostic steps on the sample, are made difficult or in fact impossible after a fixing operation. These problems result when the sample has been over- or underfixed. Although there is a known rule of thumb that the fixing time is approximately 1 h (hour) per mm (millimeter) of sample thickness, this rule of thumb is nevertheless in most cases observed only roughly, if at all, in the midst of busy laboratory operations.

Even if the laboratory worker has attempted to fix the sample correctly, the problem can occur that the laboratory worker, for example, forgets the exact point in time at which the sample was introduced into the fixative, or that he or she is busy with other tasks or is distracted at the specific point in time when the sample actually should be removed from a fixative.

Especially when it is found in the context of later treatment steps that the sample cannot be correctly processed, or that a meaningful diagnosis is impossible due to deficient fixing, all the steps must be repeated from the beginning (if a replacement sample can in fact be acquired).

### SUMMARY OF THE DISCLOSURE

The object of the present invention is therefore to describe a method for fixing a histological sample which ensures correct fixing.

This object is achieved by a method of the kind recited previously which is characterized in that a target fixing time for the sample is defined and the sample is exposed to the action of a fixative, and the exposure start time is stored in a memory associated with the sample, and the sample is withdrawn from exposure when an action time of the fixative on the sample is equal to or greater than the target fixing time.

A further object of the present invention is to describe a sample receptacle, in particular a cassette or a cassette holding apparatus or a fixing container, which is embodied to allow the user or an automatic processing apparatus to be assisted in carrying out a fixing operation.

This object is achieved by a sample receptacle which is characterized in that the sample receptacle comprises a memory in which an exposure start time can be stored, preferably automatically, which start time is defined by the beginning of the action of a fixative on the sample.

A further object of the present invention is to describe a processing apparatus for processing a histological sample, which apparatus enables correct fixing of a sample.

The object is achieved by a processing apparatus which is characterized in that the processing apparatus comprises at least one reading and/or writing means and a control apparatus, where the reading and/or writing means reads out, from a memory associated with the sample, at least one exposure start time at which the sample was exposed to the action of a fixative, and the control apparatus of the processing apparatus identifies whether the action time of the sample in the fixative is greater than or equal to a target fixing time.

A processing apparatus embodied in this fashion offers the advantage, in particular, of ensuring that the sample is not removed too soon or too late from the fixative. It is thereby possible to ensure that diagnosis of the sample downstream from the processing apparatus is possible.

The invention has the advantage of ensuring that the correct fixing time is adhered to. In particular, provision can in fact be made that a processing apparatus itself identifies the correct target fixing time. The check as to whether the action time of the fixative on the sample is equal to or greater than the target fixing time ensures that the sample is not removed too soon or too late from a fixative. It is thereby possible to ensure by way of the method that the subsequent processing steps, as well as, for example, a microscopic diagnosis of the sample following the fixing operation, are possible without difficulty. A further advantage of the invention is that a laboratory worker does not need to monitor whether the fixing operation on the sample has ended.

The “exposure start time” is regarded as that point in time at which an action of the fixative on the sample begins. The “action time” is understood for purposes of the invention as that time period during which the sample is exposed to the action of the fixative. The exposure start time represents the beginning of the action time. Ideally, the action time corresponds to the target fixing time.

According to an aspect of the invention, the sample to be fixed can be conveyed into a cassette at a time prior to the exposure start time. Arranging the sample in the cassette ensures that the sample is not freely movable within the fixative, but instead is positioned in stationary fashion by the cassette. The fixative can be provided in a vessel of a fixing container, which can be closed off e.g. by means of a cover. Before the sample is placed into the cassette, the sample can be cut in a trimming station.

Trimming and/or placement of the sample in the cassette can occur at least in part automatically.

In a particular embodiment, the memory is arranged on or in the cassette. In particular, multiple cassettes having multiple samples can be inserted into one cassette holding apparatus. One sample, or also several samples, can be contained in a cassette. Alternatively, the memory can also be arranged on or in the cassette holding apparatus.

For fixing of the samples, the cassettes and/or the cassette holding apparatus are introduced into a fixative.

The cassette holding apparatus has the advantage in particular that multiple samples from the same patient can be put into the same cassette holding apparatus. The samples of one patient can thereby be easily identified.

For example, 16 to 24 cassettes of the same patient can be put into a single cassette holding apparatus. It is of course not necessary for only cassettes of a single patient to be put into the cassette holding apparatus. It is entirely possible for cassettes having samples from different patients to be held by a single cassette holding apparatus. In addition, it is of course also possible for the cassette holding apparatus to be able to receive fewer than 16 or more than 24 cassettes. The cassette holding apparatus can be introduced into the fixative that is provided in the vessel of the fixing container.

A particular embodiment is configured in such a way that multiple samples are associated with one common memory. In particular, for example, the samples held in one cassette holding apparatus can be associated with one memory. The provision of a memory with which multiple samples are associated offers the advantage that the number of memories used is reduced, and costs can thus be decreased.

The exposure start times of multiple samples, and/or further information relating to the sample, can be stored in a single memory (or also distributed over multiple memories). In particular, information regarding further sample processing and/or the target fixing time of the samples can be written into the memory. Alternatively or additionally, an information item regarding the actual fixing time or action time can be written into the memory after the sample is withdrawn from the fixative. The information can be written, for example, by a reading and/or writing means of the trimming station. The writing of an information item into the memory can of course also occur outside the trimming station.

The memory can be an electronic or an optical memory. The memory can further comprise a transponder, for example an RFID chip. Provision of the transponder makes possible simple communication between the memory and the trimming station and/or a processing apparatus for processing the histological sample.

The target fixing time written into the memory by a reading and/or writing means can also be automatically identified beforehand. The target fixing time can, for example, be identified by the processing apparatus, and depends inter alia on the size and nature of the sample; as a rule, the larger the sample, the longer the fixing time.

Alternatively or additionally, a sample property can be measured, preferably automatically. The sample property can be the conductivity of the sample and/or the volume of the sample and/or the weight of the sample and/or the sample density. The target fixing time can be determined, preferably automatically, from the measured sample property. Identification of the sample properties offers the advantage that an exact identification of the target fixing time is possible. For the case in which a target fixing time has already been written into the memory by the reading and/or writing means, in the event of a discrepancy between the target fixing time identified by the sample property and the target fixing time stored in the memory, it can be concluded that an error exists.

In a particular embodiment, the sample can firstly be exposed to at least one first manufacturing component of the fixative. Exposure of the sample to the first manufacturing component does not yet result in fixing of the sample. At least one other, second manufacturing component can then be added into the first manufacturing component. It is only the addition of the second manufacturing component that produces a fixative that acts on the sample and enables fixing thereof. The exposure start time corresponds, as already mentioned above, to the point in time at which the completely manufactured fixative acts on the sample.

According to a further aspect of the invention, the memory can be a constituent of the sample receptacle. The sample receptacle can be a cassette or a cassette holder or a fixing container, and can comprise a sensor that detects when the manufacturing components are mixed with one another. The memory can be a constituent of the fixing container.

For the case in which mixing of the manufacturing components is detected, the sample receptacle can write the exposure start time—which is defined by the beginning of the action of the fixative, mixed from the manufacturing components, on the sample—into the memory.

According to a further aspect of the invention, the sample can pass through a plurality of processing steps in the processing apparatus. The processing apparatus can comprise a receptacle into which the fixing container is inserted. The fixing container remains in the receptacle of the processing apparatus as long as the action time is not equal to or greater than the target fixing time. For the case in which the action time is equal to or greater than the target fixing time, the processing apparatus can conclude the fixing operation. Alternatively or additionally, the processing apparatus can initiate a further processing of the sample when the action time is equal to or greater than the target fixing time. In particular, a dehydration and/or clearing and/or infiltration of the sample can occur in the processing apparatus after completion of the fixing operation. The reagents for carrying out the dehydration and/or clearing and/or infiltration of the sample can be accommodated in reagent containers provided inside the processing apparatus.

In a particular embodiment of the processing apparatus, the latter can automatically identify the target fixing time. For example, the target fixing time stored in the memory can be read out by a reading and/or writing means of the processing apparatus. The target fixing time can be written into the memory, for example, by another reading and/or writing means of the trimming station. Alternatively or additionally, the processing apparatus can determine the target fixing time based on at least one sample property. In particular, the processing apparatus can identify the target fixing time based on the conductivity of the sample and/or the volume of the sample and/or the weight of the sample and/or the sample density. Identification of the target fixing time can be accomplished automatically. The advantage of identification of the sample property by the processing apparatus is that it is possible to identify exactly when the fixing operation has ended.

The processing apparatus can comprise a measuring means that identifies the aforementioned sample property in simple fashion. Alternatively or additionally, it is possible for the sample property to be entered manually by the user of the processing apparatus.

The processing apparatus can furthermore comprise a transport means for transporting the sample. The transport means can, in particular, take the sample out of the fixing container when the action time of the sample in the fixative is greater than or equal to a target fixing time of the sample. The transport means can furthermore transport the sample and/or cassette and/or cassette holding apparatus from the fixing container into at least one reagent container of the processing apparatus when the action time of the sample in the fixative of the fixing container is greater than or equal to the target fixing time of the sample. Provision of the transport means makes it possible to achieve automatic processing of the sample by the processing apparatus after introduction into the processing apparatus. The sample that has been completely processing in the processing apparatus can be delivered, after processing, to an embedding apparatus downstream from the processing apparatus.

In a particular embodiment of the processing apparatus, at least one reading and/or writing means can communicate with the memory before and/or during and/or after introduction of the fixing container into the receptacle of the processing apparatus. In particular, the exposure start time and/or the target fixing time can be communicated to the processing apparatus, so that the processing apparatus knows when the sample can be further processed and/or when the fixing operation has ended. The processing apparatus can furthermore deposit in the memory further information regarding the further processing of the sample within the processing apparatus. The result is that after processing of the sample in the processing apparatus, a laboratory worker can easily ascertain, from the information stored in the memory, the individual processing steps through which the sample has passed.

The reading and/or writing means can be arranged outside the processing apparatus. In particular, the reading and/or writing means can be arranged separately from the processing apparatus. The reading and/or writing means can be arranged, for example, in the trimming station. Alternatively or additionally, at least one other reading and/or writing means can be arranged inside the processing apparatus. In particular, at least one reading and/or writing means can be provided in the receptacle of the processing apparatus.

A system that is made up on the one hand of the above-described sample receptacle and on the other hand of the likewise above-described processing apparatus is particularly advantageous.

### BRIEF DESCRIPTION OF THE DRAWINGS

The subject matter of the invention is schematically depicted in the drawings and will be described below with references to the Figures; identical or identically functioning elements are in most cases labeled with the same reference characters. In the drawings:

FIG. 1 schematically depicts an exemplifying embodiment of a fixing container according to the present invention; and

FIG. 2 schematically depicts an exemplifying embodiment of fixing containers and a processing apparatus according to the present invention.

### DETAILED DESCRIPTION OF THE DISCLOSURE

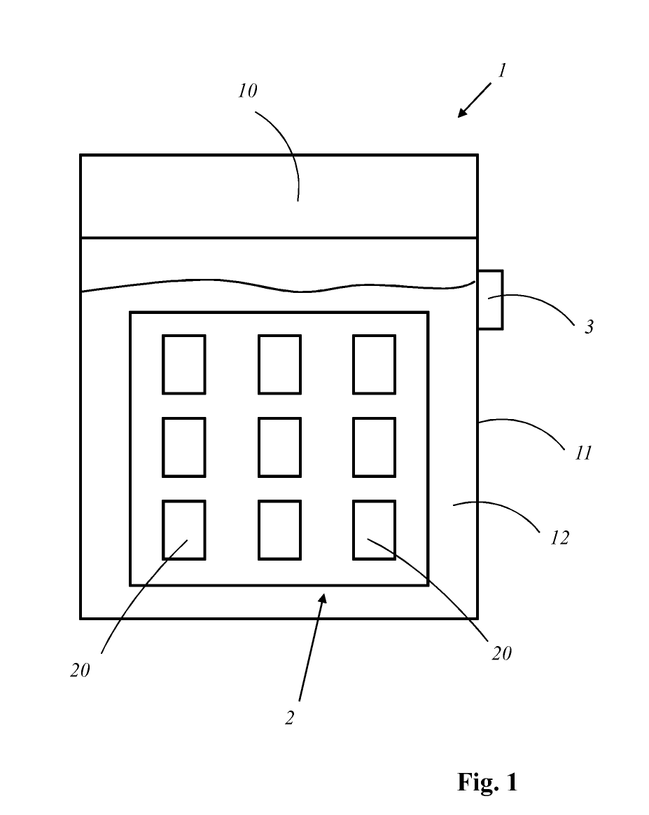

Fixing container 1 shown in FIG. 1 comprises a vessel 11 onto which a cover 10 is placed, for example screwed on. A fixative, for example formalin 12, is accommodated in vessel 11. A cassette holding apparatus 2 is also located in vessel 11.

Cassette holding apparatus 2 holds a plurality of cassettes 20, in each of which is arranged at least one sample (not depicted). Cassette holding apparatus 2, and thus cassettes 20, are completely wetted by formalin 12.

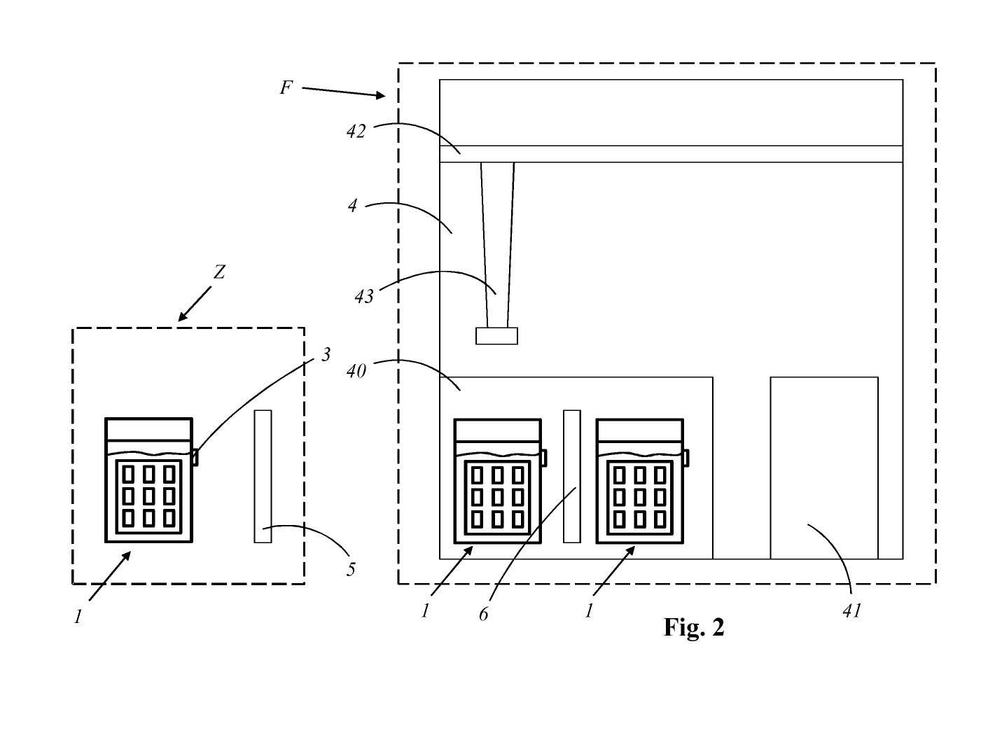

Also arranged on vessel 11 is a memory 3 that is arranged on a side of vessel 11 facing away from formalin 12. The exposure start time, and preferably the target fixing time, are stored in memory 3. Memory can comprise a transponder (not depicted) by means of which communication is possible with, for example, a processing apparatus 4 depicted in FIG. 2.

FIG. 2 shows a trimming station Z. Trimming station Z comprises a first reading and/or writing means 5 that can communicate with a memory 3 of fixing container 1 arranged in trimming station Z. Also shown in FIG. 2 is a fixing station F that contains processing apparatus 4. Trimming station Z and fixing station F are arranged separately from one another.

Processing apparatus 4 depicted in FIG. 2 comprises a receptacle 40 in which two fixing containers 1 are arranged next to one another. Receptacle 40 can be a drawer that is transferred into a pulled-out state for the reception of fixing containers 1.

Provided between the two fixing containers 1 is a second reading and/or writing means 6 that is connected to a control apparatus (not depicted) of processing apparatus 4. Processing apparatus 4 further comprises a transport apparatus for transporting cassette holding apparatus 2. The transport apparatus comprises a gripping means 43 that can move along a bar 42 inside processing apparatus 4. Gripping means 43 is furthermore embodied in such a way that it can grip a cassette holder 2 and remove it from fixing container 1.

Execution of the fixing operation will be described below. In trimming station Z, the tissue sample (not depicted in the Figures) is trimmed and put into cassette 20.

Cassette 20 is inserted into cassette holding apparatus 2. Cassette holding apparatus 2 is then introduced into formalin 12 that is present in container 11, and container 11 is closed off with cover 10.

The point in time at which cassette holding apparatus 2, and thus cassettes 20, are exposed to the formalin is then written by first reading and/or writing means 5 into memory 3 of fixing container 1. The target fixing time of the samples is furthermore written into memory 3, all of the cassettes 20 contained in cassette holding apparatus 2 being associated with memory 3.

Cassette holding apparatus 2 is introduced into receptacle 40 of processing apparatus 4. The exposure start time and/or target fixing time stored in the respective memory 3 is read out by second reading and/or writing means 6 arranged in receptacle 40. Processing apparatus 4 identifies the action time of formalin 12 on the samples contained in cassettes 20, and determines as a function of the action time whether the fixing operation has ended.

For the case in which the action time is greater than or equal to the target fixing time, cassette holding apparatus 2 is removed by gripping means 43 from fixing container 1. The removed cassette holding apparatus 2 is delivered by gripping means 43, for further processing, into reagent containers 41 contained in processing apparatus 4.

The invention has been described with reference to a particular embodiment. It is self-evident, however, that changes and modifications can be made without thereby departing from the range of protection of the Claims that follow.

### PARTS LIST

1 Fixing container

2 Cassette holding apparatus

3 Memory

4 Processing apparatus

5 First reading and/or writing means

6 Second reading and/or writing means

10 Cover

11 Vessel

12 Formalin

20 Cassette

40 Receptacle

41 Reagent container

42 Bar

43 Gripping means

F Fixing station

Z Trimming station

What is claimed is:

1. A method for fixing a histological sample, comprising:
defining a target fixing time for the sample;
exposing the sample to a fixative;
storing a start time of the exposure in a memory associated with the sample; and
withdrawing the sample from the exposure when an action time of the fixative on the sample is equal to or greater than the target fixing time.

2. The method according to claim 1, wherein the sample to be fixed is conveyed into a cassette (20) at a time prior to the exposure start time.

3. The method according to claim 2, wherein the memory (3) is arranged on or in the cassette (20).

4. The method according to claim 2, wherein multiple cassettes (20) are inserted into one cassette holding apparatus (2), and/or the memory (3) is arranged on or in a cassette holding apparatus (2).

5. The method according to claim 1, wherein the memory (3) is associated with multiple samples.

6. The method according to claim 1, wherein the memory (3) is an electronic memory or an optical memory.

7. The method according to claim 6, wherein the memory is a transponder.

8. The method according to claim 1, wherein:
a. the target fixing time is automatically identified; and/or
b. a sample property, including one or more of the following: the conductivity of the sample, the volume of the sample, the weight of the sample, and the sample density, is measured; and the target fixing time is determined from the sample property.

9. The method according to claim 1, further comprising:
exposing the sample to at least one manufacturing component of the fixative;
adding at least one further manufacturing component such that the fixative is produced from the at least one manufacturing component and the at least one further manufacturing component; and
wherein the start time of the exposure is defined as a beginning of action of the fixative, mixed from the at least one manufacturing component and the at least one further manufacturing component, on the sample.

10. The method according claim 1, wherein:
a. information regarding further sample processing is written to the memory (3); and/or
b. an information item regarding an actual fixing time is written to the memory (3) after the sample is withdrawn from the fixative.

11. An apparatus for carrying out a method according to claim 1.

12. A sample receptacle, comprising:
a cassette (20), cassette holding apparatus (2), or fixing container configured to receive a histological sample, the sample receptacle including a memory (3) in which an exposure start time, which is defined by a beginning of action of a fixative on the sample, is automatically storable.

13. A processing apparatus (4) for processing a histological sample, comprising:
at least one reading and/or writing means (5, 6) and a control apparatus;
wherein the reading and/or writing means (5, 6) is configured to read out, from a memory (3) associated with the sample, at least one exposure start time at which the sample was exposed to a fixative;
wherein the control apparatus of the processing apparatus (4) is configured to identify whether an action time of the sample in the fixative is greater than or equal to a target fixing time.

14. The processing apparatus (4) according to claim 13, wherein, when the target fixing time is reached, the processing apparatus (4) is configured to end the fixing operation and/or initiate further processing.

15. The processing apparatus (4) according to claim 13, wherein the processing apparatus (4) is configured to identify the target fixing time based on at least one sample property, including one or more of the following: a conductivity of the sample, the volume of the sample, the weight of the sample, and the sample density;
wherein the processing apparatus is configured to determine the target fixing time from the at least one sample property.

16. The processing apparatus (4) according to claim 15, further comprising a measuring means configured to measure the at least one sample property.

17. The processing apparatus (4) according to claim 13, further comprising a transport means configured to transport the sample out of the fixing container (1) when the action time of the sample in the fixative of the sample container (1) is greater than or equal to a target fixing time of the sample.

18. The processing apparatus (4) according to claim 13, further comprising a receptacle (40) configured to receive the fixing container (1);
wherein the reading and/or writing means (6) is configured to communicate with the memory (3) before and/or during and/or after introduction of the fixing container into the receptacle (40) of the processing apparatus (4).

19. The processing apparatus (4) according to claim 17, wherein the transport means is configured to transport the sample from the fixing container (1) into at least one reagent container of the processing apparatus (4).

20. A system, comprising:
a. a sample receptacle, including:
a cassette (20), cassette holding apparatus (2), or fixing container configured to receive a histological sample, the sample receptacle including a memory (3) in which an exposure start time, which is defined by a beginning of action of a fixative on the sample, is automatically storable; and
b. a processing apparatus (4), including:
at least one reading and/or writing means (5, 6) and a control apparatus;
wherein the reading and/or writing means (5, 6) is configured to read out, from the memory (3), the exposure start time;
wherein the control apparatus of the processing apparatus (4) is configured to identify whether an action time of the sample in the fixative is greater than or equal to a target fixing time.
